(19) United States
(12) Patent Application Publication
(10) Pub. No.: US 2009/0317630 A1
(43) Pub. Date: Dec. 24, 2009

(54) Multi-Layer Coated Device and Preparation Method Thereof

(76) Inventors: Meng Liu, Shenzhen (CN); Zhixin Li, Shenzhen (CN)

Correspondence Address: BRINKS HOFER GILSON & LIONE, P.O. BOX 10395, CHICAGO, IL, 60610, US

(21) Appl. No.: 12/376,184

(22) PCT Filed: Oct. 12, 2007
(86) PCT No.: PCT/CN07/70882

§ 371 Date: Feb. 3, 2009

(30) Foreign Application Priority Data
Dec. 8, 2006 (CN) 200610153118.3

(51) Int. Cl. B32B 5/00; B05D 1/36

(52) U.S. Cl. 428/336; 427/58

(57) ABSTRACT

Disclosed herein is a multi-layer coated product comprising a substrate, and a multi-layer coating including an undercoat and a topcoat which are formed on the substrate in sequence, have alcohol resistance, and are in a different color from each other, wherein the multi-layer coating further includes an intermediate coat having no alcohol resistance between the undercoat and the topcoat. Also disclosed herein is a method for preparing the multi-layer coated product. Since the intermediate coat of the multi-layer coated product has no alcohol resistance, when the intermediate coat and topcoat on the backlight part is removed by the laser engraving, it is sufficient that the laser intensity is controlled to be higher than the laser intensity required for completely removing the topcoat and lower than the laser intensity that affects the undercoat, the time required for determining the laser intensity and scrubbing can be shortened, and thereby the production efficiency of said multi-layer coated product can be improved.

### FIELD OF THE INVENTION

The present invention relates to a multi-layer coated product and a preparation method thereof.

### BACKGROUND OF THE INVENTION

Presently, with the development of electronic products, increasingly more attention is paid to keys or keyboards which are functional components of the electronic products. The keys or keyboards of electronic products such as a mobile telephone, an electronic dictionary, or a personal digital assistant (PDA), are usually prepared by coating plastics as a substrate with two layers of coating (i.e., an undercoat and a topcoat), to obtain multi-layer coated products; and then, removing the topcoat on the backlight part of the key or the keyboard (i.e., the part with letter or pattern), to expose the undercoat on the part, so that the undercoat shows backlight color, while the topcoat shows the shell color.

The topcoat on the backlight part is usually removed by laser engraving, at an appropriate laser intensity to ensure that the topcoat is completely removed but the undercoat is not affected. Accordingly, it takes a long testing time to determine the appropriate laser intensity. Furthermore, since the topcoat on different parts of the same key or keyboard may have a different thickness, above requirement may not be met with the same laser intensity, and as a result, the production efficiency will be lowered.

Moreover, in order to prevent the undercoat from being affected during the laser engraving, the laser intensity used in the laser engraving is usually slightly lower than those required for completely removing the topcoat, such that residual topcoat may remains on the backlight part after the laser engraving, and has to be removed by scrubbing with alcohol. In order to prevent the undercoat and the topcoat on other parts from being scrubbed off by alcohol, the undercoat and topcoat both have the alcohol resistance; therefore, it takes a long time to scrub off the residual topcoat on the backlight part with alcohol, and as a result, the production efficiency is lowered.

As described above, the multi-layer coated products of the prior art have the drawback of low production efficiency.

### SUMMARY OF THE INVENTION

The object of the present invention is to provide a multi-layer coated product featured with high production efficiency and the preparation method thereof, so as to overcome the drawback of low production efficiency of the prior art multi-layer coated products.

The present invention provides a multi-layer coated product, comprising:

a substrate, and
a multi-layer coating including an undercoat and a topcoat which are formed on the substrate in sequence, have alcohol resistance, and are in a different color from each other, wherein the multi-layer coating further includes an intermediate coat having no alcohol resistance between the undercoat and the topcoat.

The present invention also provides a preparation method for the multi-layer coated product, including the step of forming an undercoat and a topcoat which have alcohol resistance and are in a different color from each other on a substrate in sequence, wherein it further includes the step of forming an intermediate coat having no alcohol resistance between the undercoat and the topcoat.

The multi-layer coated product provided by the present invention comprises a substrate and a multi-layer coating comprising an undercoat, an intermediate coat, and a topcoat formed on the substrate in sequence, wherein the undercoat and the topcoat both have the alcohol resistance, while the intermediate coat has no alcohol resistance. When the intermediate coat and topcoat on the backlight part are removed by the laser engraving, it is sufficient that the laser intensity is controlled to be higher than the laser intensity required for completely removing the topcoat and lower than the laser intensity that affects the undercoat. Even if the laser intensity is lower than the laser intensity required for completely removing the intermediate coat and the topcoat, the residual intermediate coat having no alcohol resistance on the backlight part can be removed easily with alcohol or alcoholic solution, while the topcoat and undercoat having alcohol resistance will not be scrubbed off by the alcohol or alcoholic solution. Therefore, the time required for determining the laser intensity and scrubbing can be shortened, and thereby the production efficiency of said multi-layer coated product can be improved.

### DETAILED DESCRIPTION OF THE EMBODIMENTS

The multi-layer coated product provided by the present invention comprises:

a substrate, and
a multi-layer coating including an undercoat and a topcoat which are formed on the substrate in sequence, have alcohol resistance, and are in a different color from each other, wherein the multi-layer coating further includes an intermediate coat having no alcohol resistance between the undercoat and the topcoat.

Said undercoat and topcoat can be the same with the undercoat and topcoat on the keys or keyboards of electronic products in the prior art.

Said undercoat, topcoat, and intermediate coat can each independently have a thickness of 3 to 15 μm, preferably 5 to 9 μm.

Said undercoat and topcoat can independently comprise a film-forming material, chloride-vinyl acetate resin, and a coloring agent, and optional one or more of an adjusting agent and conventional auxiliary agent such as leveling agent and anti-settling agent, etc. In the undercoat or the topcoat, relative to 100 parts by weight of the film-forming material, the content of said chloride-vinyl acetate resin can be 2 to 50 parts by weight, preferably 5 to 40 parts by weight, and more preferably 10 to 30 parts by weight; the content of said coloring agent can be 3 to 80 parts by weight, preferably 10 to 70 parts by weight, and more preferably 20 to 60 parts by weight; the content of said adjusting agent can be 0 to 20 parts by weight, preferably 2 to 15 parts by weight, and more preferably 5 to 12 parts by weight; and the content of said auxiliary agent can be 0 to 20 parts by weight, preferably 2 to 15 parts by weight, and more preferably 5 to 12 parts by weight.

Said intermediate coat can comprise film-forming material, and optional one or more of a coloring agent, an adjusting agent, and conventional auxiliary agent such as leveling agent and anti-settling agent, etc. In the intermediate coat, relative to 100 parts by weight of the film-forming material, the content of said coloring agent can be 0 to 80 parts by weight, preferably 10 to 70 parts by weight, and more preferably 20 to 60 parts by weight; the content of said adjusting agent can be 0 to 20 parts by weight, preferably 2 to 15 parts by weight, and more preferably 5 to 12 parts by weight; and the content of said auxiliary agent can be 0 to 20 parts by weight, preferably 2 to 15 parts by weight, and more preferably 5 to 12 parts by weight.

Said film-forming material can be any conventional film-forming material used in the prior art coated products; for example, the film-forming material contained in the undercoat, the intermediate coat, and the topcoat may be each independently one or more selected from a thermoplastic acrylate resin, a hydroxy acrylic resin, a self-curing alkyd resin, and an aldehyde ketone resin, and among them the thermoplastic acrylate resin is preferred. Said thermoplastic acrylate resin has been well known to those skilled in the art, and is commercially available or prepared through the copolymerization of acrylate, methacrylate, and other olefin monomers by a known method. For example, said thermoplastic acrylate resin can include, but not limited to IC12103, IC12106, Rohm&Haas A-11, Rohm&Haas A-12, Rohm&Haas B60, Rohm&Haas B66, Rohm&Haas A-21, Mitsubishi BR-113, Mitsubishi BR-116, Mitsubishi MB-2952, Mitsubishi MB2660, Mitsui 101, and Mitsui 102, etc. Above trade names are well known to those skilled in the art.

The chloride-vinyl acetate resin contained in said undercoat and said topcoat can be each independently one or more selected from vinyl chloride-vinyl acetate, vinyl chloride-vinyl acetate-hydroxy acrylate, vinyl chloride-vinyl acetate-maleate, and vinyl chloride-vinyl acetate-vinyl alcohol ester. Based on its total weight, the chloride-vinyl acetate resin contains 50 to 95 wt %, preferably 70 to 90 wt % of vinyl chloride; 5 to 40 wt %, preferably 8 to 25 wt % of vinyl acetate; 0 to 20 wt %, preferably 0.5 to 10 wt % of hydroxy acrylate; 0 to 20 wt %, preferably 0.5 to 10 wt % of vinyl alcohol; and 0 to 10 wt %, preferably 0.5 to 5 wt % of maleic acid. The chloride-vinyl acetate resin has a number-average molecular weight of 10000 to 50000, preferably 13000 to 42000. Said chloride-vinyl acetate resin is commercially available, such as E15/45M from Eastman, VINNOL LL4320 from WACKER (Germany), UCAR VAGH, UCAR VAGK and VMCH from UCAR (USA), T-33 from BSK (Canada), and SOBIN A from SOBIN (Japan), etc.

Said chloride-vinyl acetate resin is insoluble in alcohol solvents, for example, vinyl chloride-vinyl acetate is insoluble in alcohol, and therefore has high alcohol resistance. Since said topcoat and undercoat contain the chloride-vinyl acetate resin, they have alcohol resistance, and therefore will not be affected when the coating is scrubbed with alcohol or alcoholic solution. Since the intermediate coat does not contain the chloride-vinyl acetate resin, it has no alcohol resistance, and therefore, the residual intermediate coat on the backlight part can be scrubbed off easily with alcohol or alcoholic solution.

Said coloring agent can be any conventional coloring agent used in the prior art coated products, for example, the coloring agent contained in said undercoat, intermediate coat, and topcoat can be each independently one or more selected from color slurry, pearlescence, fluorescent powder, dye, organic pigment, and inorganic pigment. Said organic pigment can include, but not limited to carbon black and titanium white. Said organic pigment can include, but not limited to azoic triaryl methane, anthraquinone, phthalocyanine, thioindigo, isoindazole ketone, quinaldine ketone, triphenyl diazine, and methylenimine groups, etc. Said coloring agent is commercially available, for example, the white color slurry can be Dema TC21 from Shibis or oily color slurry 844-0061 from DEGUSSA.

The coloring agent contained in the undercoat can be selected with reference to the expected backlight color; and the coloring agent contained in the topcoat can be determined with reference to the appearance color of said multi-layer coated product as required, as long as the undercoat and the topcoat are in a different color. Said intermediate coat contains or doesn't contain the coloring agent; if said intermediate coat contains color blending agent, the color blending agent can be any one or a mixture of above coloring agents. Preferably, said intermediate coat is in black color, because a black intermediate coat has higher light absorbing capability and can absorb more laser radiation, to facilitate the black intermediate coat and the topcoat to burn quickly and form clear engraved pattern. More preferably, said intermediate coat contains carbon black to form a black intermediate coat. Since carbon black is easy to burn at heating, the intermediate coat containing carbon black can be easily removed by the laser engraving.

Said adjusting agent can be any conventional adjusting agent in the prior art coated products, for example, the adjusting agent contained in said undercoat, intermediate coat, and topcoat can be independently selected from cellulose acetate butyrate (CAB) and rottweil powder. Said adjusting agent is used to adjust the arrangement of said coloring agent and surface properties of the coat layers. Said intermediate coat preferably contains CAB as the adjusting agent, because CAB can further reduce the alcohol resistance of the intermediate coat to easily remove the residual intermediate coat with alcohol or alcoholic solution.

The type and amount of said leveling agent is well known to those skilled in the art; for example, the leveling agent contained in said undercoat, intermediate coat, and topcoat can be each independently one or more selected from EFKA3883, EFKA3886, EFKA3600, EFKA3777, BYK366, BYK333, BYK307, and DEGO410. Among them, EFKA series are the products of EFKA (Netherlands), BYK series are products of BYK Company, and DEGO series are products of DEGO (Germany); and above trade names are well known to those skilled in the art.

Said anti-settling agent is used to form powerful network structure in the resin composition to afford excellent thixotropic property to the system, so as to effectively prevent settlement and agglomeration of the color filler in the coating. The type and volume of said anti-settling agent are known to those skilled in the art; for example, Agent 201P or 229 from Taiwan Deuchem, DS6500/6800-20X or DS5000-10X from TAVY (USA), and 6900-20X or 4200-10 from Kusumoto Chemicals, Ltd. (Japan) can be used; above trade names are well known to those skilled in the art.

The multi-layer coated product provided by the present invention can be used as a component for any appliance that requires backlight pattern, and is especially suitable for keyboards or keys of electronic products. As required, the intermediate coat and topcoat in the backlight pattern part can be removed to expose the undercoat and exhibit the backlight pattern. Said substrate can be any conventional substrate applicable to components that require backlight pattern, and plastic material is preferred.

The preparation method for multi-layer coated product provided by the present invention includes the step of forming an undercoat and a topcoat which have alcohol resistance and are in a different color from each other on a substrate in sequence, wherein it further includes the step of forming an intermediate coat having no alcohol resistance between the undercoat and the topcoat.

Wherein, said undercoat, topcoat, and intermediate coat can be formed by any conventional coating preparation method, respectively. For example, the coating compostion can be mixed with a diluting agent, and the mixture is coated on the substrate and then dried. The coating composition can be mixed with the diluting agent at a weight ratio of 1:0.5-2. Said drying method can be any prior art method, preferably drying for 5-15 min. at 50-60° C. Said diluting agent can be any conventional diluting agent in the field, such as one or more of toluene, ethyl acetate, butyl acetate, isobutyl acetate, propyl acetate, ethanol, normal butyl alcohol, cyclohexanone, dimethylbenzene, methylisobutyl ketone, acetone, butanone, ethylene glycol monobutyl ether, and propylene glycol monobutyl ether.

Said undercoat can be formed with a prime coating composition; said topcoat can be formed with a finish coating composition; and said intermediate coat can be formed with an intermediate coating composition. The prime coating composition, finish coating composition, and intermediate coating composition each have the same components as the undercoat, topcoat, and intermediate coat, respectively, with the only difference that the coating compositions further contain a diluting agent. Wherein, the type and amount of said diluting agent are known to those skilled in the art. Relative to 100 parts by weight of the film-forming material, the amount of said diluting solvent is preferably 5 to 150 parts by weight, and more preferably 10 to 120 parts by weight.

Since the prime coating composition and the finish coating composition contain chloride-vinyl acetate resin having the alcohol resistance, the diluting agent in them can not be alcohol solely. In said prime coating composition and finish coating composition, said diluting agent can be one or more of toluene, ethyl acetate, butyl acetate, isobutyl acetate, propyl acetate, cyclohexanone, dimethylbenzene, methylisobutyl ketone, acetone, butanone, ethylene glycol monobutyl ether, and propylene glycol monobutyl ether, or a mixture of ethanol and/or normal butyl alcohol with one or more of the above diluting agents. In said intermediate coating composition, said diluting agent can be one or more of toluene, ethyl acetate, butyl acetate, isobutyl acetate, propyl acetate, ethanol, normal butyl alcohol, cyclohexanone, dimethylbenzene, methylisobutyl ketone, acetone, butanone, ethylene glycol monobutyl ether, and propylene glycol monobutyl ether.

Above coating compositions can be prepared with the preparation method for conventional coating compositions, for example, the components of above coating layers, such as film-forming material and optional chloride-vinyl acetate resin, coloring agent, adjusting agent, auxiliary agent, and diluting solvent, can be mixed homogeneously.

Hereunder the present invention will be described in more detail in the examples.

### Examples 1 to 5

The examples 1 to 5 are provided to prepare the coating compositions that form the coating layers.

The components shown in Table 1 were mixed homogeneously, the mixture was filtered to obtain a slurry, and then the slag was removed therefrom, to obtain the coating compositions A1, A2, A3, B1, and B2. The amount of the components in Table 1 was denoted in parts by weight.

TABLE 1

| | | Example 1 | Example 2 | Example 3 | Example 4 | Example 5 |
|---|---|---|---|---|---|---|
| Component | | A1 | A2 | A3 | B1 | B2 |
| Film-forming | Type | Thermoplastic | Thermoplastic | Thermoplastic | Thermoplastic | Thermoplastic |
| material | | acrylic resin | acrylic resin | acrylic resin | acrylic resin | acrylic resin |
| | | (Mitsubishi 2952) | (Mitsubishi 2952) | (Mitsubishi 2952) | (Mitsubishi BR113) | (Mitsubishi BR113) |
| | amount | 100 | 100 | 100 | 100 | 100 |
| Chloride- | Type | Vinyl | Vinyl | Vinyl | — | — |
| vinyl acetate | | chloride-vinyl | chloride-vinyl | chloride-vinyl | | |
| resin | | acetate-maleate | acetate (SOBIN C | acetate-dicarbonate | | |
| | | (VMCH from UCAR) | from SOBIN (Japan)) | (LL4320 from WACKER) | | |
| | amount | 25 | 30 | 15 | 0 | 0 |
| Coloring | Type | White color | Red color | Green color | Black color | Black color |
| agent | | slurry (Dema | slurry (Dema | slurry (Dema | slurry (Dema | slurry (Dema |
| | | TC25 from Shibis) | TC29 from Shibis) | TC24 from Shibis) | TC21 from Shibis) | TC21 from Shibis) |
| | amount | 60 | 40 | 50 | 50 | 50 |
| Adjusting | Type | CAB resin | — | CAB resin | CAB resin | CAB resin |
| agent | | (Eastman | | (Eastman | (Eastman | (Eastman |
| | | CAB381-20BP) | | CAB381-20BP) | CAB381-0.5) | CAB381-0.5) |
| | amount | 10 | 0 | 8 | 10 | 9 |
| Anti-settling | Type | — | 201P from | 201P from | 201P from | 201P from |
| agent | | | Taiwan | Taiwan | Taiwan | Taiwan |
| | | | Deuchem | Deuchem | Deuchem | Deuchem |
| | amount | 0 | 3 | 3 | 3 | 3 |
| Leveling | Type | EFKA3883 | EFKA3883 | — | — | EFKA3883 |
| agent | Volume | 2 | 2 | 0 | 0 | 2 |
| Diluting | Type | Ethyl acetate | Ethyl acetate | Ethyl acetate | Ethyl acetate | Ethyl acetate and |
| agent | | and acetone at a | and toluene at | and acetone at | and alcohol at | normal butyl alcohol |
| | | weight ratio of | a weight ratio | 1:2 weight | 1:2 weight | at 1:2 weight |
| | | 1:2 | of 1:2 | ratio | ratio | ratio |
| | amount | 120 | 100 | 100 | 120 | 100 |

### Example 6

The example 6 is provided to describe the multi-layer coated product and the preparation method thereof according to the present invention.

The coating composition A1 obtained in the example 1 was mixed with ethyl acetate in a weight ratio of 1:0.8, and then the mixture was coated on a transparent thermoplastic keyboard, and baked for 10 min. at 60° C. to form the undercoat. Next, with the same method, the intermediate coat and topcoat were formed in sequence with the coating composition B1 obtained in example 4 and the coating composition A2 obtained in example 2, to obtain the multi-layer coated product D1.

### Examples 7 to 11

The examples 7 to 11 are provided to describe the multi-layer coated product and the preparation method thereof according to the present invention.

With the method used in example 6, the undercoat, intermediate coat and topcoat were formed on a transparent thermoplastic keyboard in sequence, to obtain the multi-layer coated products D2 to D6. The coating compositions used to form the undercoat, intermediate coat and topcoat were shown in Table 2 below.

### Comparative Examples 1 to 3

The comparative examples 1-3 are provided to describe the multi-layer coated products of the prior art.

With the method used in example 6, the undercoat, and topcoat were formed on a transparent thermoplastic keyboard in sequence, to obtain the multi-layer coated products CD1, CD2, and CD3. The coating compositions used to form the undercoat and topcoat were shown in Table 2 below.

### Examples 12 to 17

The examples 12-17 are provided to describe the influence of the multi-layer coated products D1 to D6 prepared in examples 6-11 on the laser engraving process.

A letter “A” was engraved on the multi-layer coated products D1 to D6 prepared in examples 6 to 11 with a laser engraving machine. The laser engraving process included a pre-commissioning procedure and a post-engraving alcohol scrubbing procedure. The pre-commissioning procedure shall be carried out appropriately to ensure the engraved pattern exhibits the undercoat color, avoid residual intermediate coat or topcoat as far as possible, and prevent laser penetration into the undercoat. The post-engraving alcohol scrubbing procedure shall be carried out appropriately to ensure the dust produced in laser engraving is removed and the residual intermediate coat or topcoat is scrubbed off completely, so that the undercoat is exposed. The time for the pre-commissioning procedure, and the time for the post-engraving alcohol scrubbing procedure were recorded, and the sum of them, i.e., the total time, was calculated. The result was shown in Table 2.

### Comparative Examples 4 to 6

The comparative examples 4 to 6 are provided to describe the influence of the multi-layer coated products CD1, CD2 and CD3 prepared in the comparative examples 1 to 3 on the laser engraving process.

A letter “A” was engraved on the multi-layer coated products CD1, CD2 and CD3 prepared in the comparative examples 1-3 with the method used in examples 12-17. The time for the pre-commissioning procedure, the time for the post-engraving alcohol scrubbing procedure, and the total time were recorded. The result was shown in Table 2.

TABLE 2

| | Multi-layer | | Time (min.) for the | Time (min.) for the | |
|---|---|---|---|---|---|
| | Coated | Coating | Pre-Commissioning | Alcohol Scrubbing | Total Time |
| Example No. | Product No. | Composition | Procedure | Procedure | (min.) |
| Example 12 | D1 | A1 + B1 + A2 | 2 | 0.5 | 2.5 |
| Example 13 | D2 | A1 + B2 + A2 | 2 | 0.5 | 2.5 |
| Comparative | CD1 | A1 + A2 | 8 | 5 | 13 |
| Example 4 | | | | | |
| Example 14 | D3 | A1 + B1 + A3 | 1.5 | 0.5 | 2 |
| Example 15 | D4 | A1 + B2 + A3 | 2 | 0.5 | 2.5 |
| Comparative | CD2 | A1 + A3 | 10 | 6 | 16 |
| Example 5 | | | | | |
| Example 16 | D5 | A2 + B1 + A3 | 2 | 0.5 | 2.5 |
| Example 17 | D6 | A2 + B2 + A3 | 1.5 | 0.5 | 2 |
| Comparative | CD3 | A2 + A3 | 9 | 8 | 17 |
| Example 6 | | | | | |

It could be seen from the result in Table 2 that compared to the multi-layer coated products CD1, CD2 and CD3 obtained in the comparative examples 1-3, the multi-layer coated products D1 to D6 obtained in examples 6 to 11 of the present invention requires much less time for the pre-commissioning procedure and alcohol scrubbing procedure during the laser engraving process, which indicates that the production efficiency of the multi-layer coated product according to the present invention is prominently increased.

1-12. (canceled)

13. A multi-layer coated device, comprising:
a substrate; and
a multi-layer coating including an undercoat, a topcoat, and an intermediate coat disposed between the undercoat and the topcoat;
wherein the undercoat and the topcoat are insoluble in alcohol solvents, and the intermediate coat is soluble in alcohol solvents.

14. The device of claim 13, wherein the undercoat, the intermediate coat, and the topcoat each independently have a thickness of about 3-15 μm.

15. The device of claim 13, wherein the undercoat, the intermediate coat, and the topcoat each independently comprise a film-forming material.

16. The device of claim 15, wherein the undercoat, the intermediate coat, and the topcoat each independently comprise a coloring agent.

17. The device of claim 16, wherein the undercoat, the intermediate coat, and the topcoat each independently comprise an adjusting agent and an auxiliary agent.

18. The device of claim 17, wherein the undercoat and the topcoat each independently comprise a chloride-vinyl acetate resin.

19. The device of claim 18, wherein the undercoat and the top coat each independently comprise the film-forming material of about 100 parts by weight, the chloride-vinyl acetate resin of about 2-50 parts by weight, the coloring agent of about 3-80 parts by weight, the adjusting agent of about 0-20 parts by weight, and the auxiliary agent of about 0-20 parts by weight.

20. The device of claim 18, wherein the intermediate coat comprises the film-forming material of about 100 parts by weight, the coloring agent of about 0-80 parts by weight, the adjusting agent of about 0-20 parts by weight, and the auxiliary agent about 0-20 parts by weight.

21. The device of claim 15, wherein the film-forming material in the respective coat is selected from the group consisting of a thermoplastic acrylate resin, a hydroxy acrylic resin, a self-curing alkyd resin, an aldehyde ketone resin, and combinations thereof.

22. The device of claim 18, wherein the chloride-vinyl acetate resin is selected from the group consisting of vinyl chloride-vinyl acetate, vinyl chloride-vinyl acetate-hydroxy acrylate, vinyl chloride-vinyl acetate-maleate, vinyl chloride-vinyl acetate-vinyl alcohol ester, and combinations thereof.

23. The device of claim 22, wherein the chloride-vinyl acetate resin comprises the vinyl chloride of about 50-95% by weight, the vinyl acetate of about 5-40% by weight, the hydroxy acrylate of about 0-20% by weight, the vinyl alcohol of about 0-20% by weight, and the maleic acid of about 0-10% by weight.

24. The device of claim 22, wherein the chloride-vinyl acetate resin has a number-average molecular weight of about 10,000-50,000.

25. The device of claim 16, wherein the coloring agent is selected from the group consisting of a color slurry, a pearlescence, a fluorescent powder, a dye, an organic pigment, an inorganic pigment, and combinations thereof.

26. The device of claim 25, wherein the coloring agent is carbon black.

27. The device of claim 17, wherein the adjusting agent is selected from the group consisting of cellulose acetate butyrate, rottweil powder, and combinations thereof.

28. The device of claim 19, wherein the auxiliary agent is selected from the group consisting of an anti-settling agent, a leveling agent, and combinations thereof.

29. A method for the preparation of a multi-layer coated device, comprising:
forming an undercoat on a substrate of a device;
forming an intermediate coat on the undercoat; and
forming a topcoat on the intermediate coat;
wherein the undercoat and the topcoat are insoluble in alcohol solvents; and the intermediate coat is soluble in alcohol solvents.

30. The method of claim 29, wherein the undercoat is formed from a prime coating composition, the intermediate coat is formed from an intermediate coating composition, and the topcoat is formed from a finish coating composition.

31. The method of claim 30, wherein the prime coating composition and the finish coating composition each independently comprise a film-forming material of about 100 parts by weight, a diluting agent of about 5-150 parts by weight, a chloride-vinyl acetate resin of about 2-50 parts by weight, a coloring agent of about 3-80 parts by weight, an adjusting agent of about 0-20 parts by weight, and an auxiliary agent of about 0-20 parts by weight.

32. The method of claim 30, wherein the intermediate coating composition comprises a film-forming material of about 100 parts by weight, a diluting agent of about 5-150 parts by weight, a coloring agent of about 0-80 parts by weight, an adjusting agent of about 0-20 parts by weight, and an auxiliary agent of about 0-20 parts by weight.

33. The method of claim 31 or 32, wherein the film-forming material in each coat is independently selected from the group consisting of a thermoplastic acrylate resin, a hydroxy acrylic resin, a self-curing alkyd resin, an aldehyde ketone resin, and combinations thereof.

34. The method of claim 31, wherein the prime coating composition and the finish coating composition comprise a chloride-vinyl acetate resin, selected from the group consisting of vinyl chloride-vinyl acetate, vinyl chloride-vinyl acetate-hydroxy acrylate, vinyl chloride-vinyl acetate-maleate, vinyl chloride-vinyl acetate-vinyl alcohol ester, and combinations thereof.

35. The method of claim 34, wherein the chloride-vinyl acetate resin comprises the vinyl chloride of about 50-95% by weight, the vinyl acetate of about 5-40% by weight, the hydroxy acrylate of about 0-20% by weight, the vinyl alcohol of about 0-20% by weight, and the maleic acid of about 0-10% by weight.

36. The method of claim 35, wherein the chloride-vinyl acetate resin has a number-average molecular weight of about 10,000-50,000.
